(19) United States
(12) Patent Application Publication
(10) Pub. No.: US 2017/0193118 A1
(43) Pub. Date: Jul. 6, 2017

(54) Search Engine with Easy Marking of Relevant and Irrelevant Links, and Summary and Sharing of Searches

(71) Applicant: Jerry Edward Pratt, Tallahassee, FL (US)

(72) Inventor: Jerry Edward Pratt, Tallahassee, FL (US)

(21) Appl. No.: 15/294,102

(22) Filed: Oct. 14, 2016

Related U.S. Application Data
(60) Provisional application No. 62/241,173, filed on Oct. 14, 2015.

(51) Int. Cl. G06F 17/30; G06F 3/0482

(52) U.S. Cl. CPC G06F 17/30867; G06F 17/30398; G06F 17/30554; G06F 3/0482

(57) ABSTRACT

A system, whereby a user can designate search results in terms of relevancy. These designations are used to alter the search process itself. In the preferred embodiments, each piece of data returned by the search engine has associated Search Refinement Buttons. As the user chooses what is relevant or not, the system generates a database of information that refines the original search result. The result is thereby targeted toward the user's desires.

### CROSS-REFERENCES TO RELATED APPLICATIONS

This non-provisional patent application claims the benefit of an earlier-filed provisional application. The provisional application was filed on Oct. 14, 2015. It listed the same inventor and was assigned application Ser. No. 62/241,173.

### STATEMENT REGARDING FEDERALLY SPONSORED RESEARCH OR DEVELOPMENT

Not Applicable.

### MICROFICHE APPENDIX

Not Applicable

### BACKGROUND OF TOE INVENTION

1. Field of the Invention

This invention relates to the field of software search engines. More specifically, the invention comprises a method allowing a user to easily mark the relevancy of results and thereby alter the result ranking.

2. Description of the Related Art

The invention provides a much needed improvement in how the world does search. In nearly every internet and database search engine, the user is given a search box in which the user can enter search queries. The search results often contain irrelevant information the user is not interested in. This is usually due to the ambiguity of language, and the multiple meanings of words. For example, if one does an internet search on “plant”, numerous results on numerous topics are returned, from various species of plants, to the musician Robert Plant, to various power plants. It is often difficult tor a user to determine additional search phrases that can help refine the search. It can be a very cumbersome process when the user is looking tor an esoteric piece of information. In addition, often when a user is doing a search, they are interested in reading a variety of pages and then revisiting the pages that they found most relevant. However, them are no good methods on typical search engines to record the items that were most valuable. Instead, the user has to often perform the search over again, or look into the browsing history and examine all the visited pages, including pages that the user found irrelevant, in order to find the pages that the user liked. What is needed is a system that allows a human-in-the-loop interaction so that a user can teach the search engine and thereby improve the search process.

### BRIEF SUMMARY OF THE PRESENT INVENTION

The present invention provides a system whereby a user can designate search results in terms of relevancy. These designations are used to alter the search process itself. In the preferred embodiments, each piece of data returned by the search engine has associated Search Refinement Buttons. As the user chooses what is relevant or not, the system generates a database of information that refines the original search result. The result is thereby targeted toward the user's desires.

### BRIEF DESCRIPTION OF THE SEVERAL VIEWS OF THE DRAWINGS

FIG. 1 depicts a flow chart illustrating one embodiment of the invention.

FIG. 2 depicts a flowchart illustrating a second embodiment of the invention.

FIG. 3 illustrates a search return page annotated according to one embodiment of the present invention.

FIG. 4 is a diagram showing how various physical components may be used in the present invention.

FIG. 5 is a screenshot showing how the present invention may be implemented in an existing search engine.

FIG. 6 is a screenshot showing how the present invention may be implemented in an existing search engine.

FIG. 7 a screenshot showing how the present invention may be implemented in an existing search engine.

### REFERENCE NUMERALS IN THE DRAWINGS

10 operator
12 search query entry box
14 relevant button
16 irrelevant button
18 highlighted portion
100 search query
110 operator search interface
120 search engine
130 search refinement engine
140 search results
150 relevancy button
151 relevancy button
152 relevancy button
153 relevancy button
155 search summary button
160 search refinement packet
170 refined search query
200 relevancy information
210 relevance score

### DETAILED DESCRIPTION OF THE INVENTION

In the present invention, while the user is. doing an internet search, or a document, search, etc., for each result or text blurb, or unit of search result data, the user can mark the relevancy of that piece of data. Each search result and other pieces of data have associated Search Refinement Buttons, such as a “relevant” button, a “not sure” button and an “irrelevant” button, or perhaps a selector to choose from a relevancy score of 1 to 10 or other means to quickly indicate relevancy. As the user chooses what is relevant or not, the system generates a database of information, which is processed using a combination of heuristic rules, statistical analysis, and or machine learning techniques to refine the user's search. This can be used for any type of search, from standard internet searches, such as on Google, to electronic commerce searches, such as on eBat, to patent prior art searches, to medical documents for diagnostics, to files on the user's own hard drive or on the user's cloud server, etc. Essentially any Search Engine that produces Search Results could benefit from the invention, by the addition of Search Relevancy Buttons and a Search Refinement Engine. As the user searches, his or her preferences are recorded, as well as documents that he or she found relevant may be automatically downloaded or added to the user's cloud server and then indexed. At any given time the user can see a summary of their search, including hyperlinks to any pages or other content that he or she marked as relevant, not sure, and irrelevant.

Consider the following example. You are doing a research project on the history of submarines. You search for “submarine” on a search engine. It states 52,600,000 results. On the first page you mark the following Search Results as irrelevant by clicking on the irrelevant Button next to each of the results:
Drug-Sub Culture—The Latest Way to Get Cocaine
Submarine: A Novel—Amazon.com
Poison-Injecting Robot Submarine Assassinates Sea Stars
Submarine Channel|Free Your Screen
Harvard's Robot Bee Is Now Also a Submarine
Ex-defence procurement boss Warren King urges one-year delay to $50 billion submarine decision
Submarine (2010)—IMDb
   You also mark as relevant the following links by clicking on the Relevant Button next to each of the results:
Submarine—Wikipedia, the free encyclopedia
Explore the Four Classes of US Navy Submarines: Navy.com

Based on these markings, the system now knows that you are not interested in the movie Submarine, the various robotic submarines, delivering cocaine using submarines, etc. It will then eliminate results that have strong relevancy to those categories in which you marked irrelevant. The system will refine your search and present new Search Results. You can then continue to mark Search Results as relevant or irrelevant, using the Search Relevancy Buttons until the majority of the pages that it returns are ones that you are looking for.

As you click the Relevant or Irrelevant or NotSure buttons, the information will be recorded and new results will pop up. These results will start having less probability of being related to the things you marked irrelevant and more probability of being related to the things you marked as being relevant. In addition, keywords associated with your relevant searches will appear in a box, as well as keywords associated with irrelevant searches. You can then click on these words and score their relevance, as well as antonyms and synonyms.

As you progress, a database of information is created. This database may include things such as the web pages that were marked as relevant or irrelevant, statistics on the web pages, such as word counts, a web of linked pages to the pages that were marked, etc. Various heuristics, statistical approaches, and AI techniques will be used to determine the relevance of additional pages that the user has not yet marked. For example, a variation of the Google Page Rank algorithm could be used, with the relevancy score input by the user as the seed scores of marked pages and then branching out from those pages to pages linked from or to those pages.

The user will be able to see the various search heuristics that they used, and those that were automatically deduced by the system. Those entered by the user can be in one color for example, and those by the system can be in another color. The user can verify the machine generated heuristics, or mark them as invalid as the case may be.

The user can also mark additional content, which is not part of the Search Engine Results, as relevant or irrelevant as the user is surfing the web. For example, the user should be able to highlight text on a web page, or in a document, and mark it as relevant or irrelevant. The system can then use that text to refine the search.

In our example through this system, the user should start getting to highly relevant pages, such as:
Take 'Er Down Submarine History (which shows up on page 19 of a Google search for submarine).

In addition, the user should be able to mark a web page that the user visits as relevant or irrelevant, even if it isn't part of a search, but instead found through the user surfing the web. For example, after clicking through a few pages, the user finds the url:

http://www.eugeneleeslover.com/AMMUNIRION/APR-53-NAUTILUS.html

The user can then mark that page as a relevant, page and it gets added to the database associated with the current search.

As the user finds images, pdfs, and other media, and marks them as being relevant, these documents could be automatically downloaded or stored on a remote server, such as DropBox. This is as opposed to the time consuming current process of having to right click, select the save as option, find the directory of interest, etc. Instead those documents could be downloaded and linked to the relevant entries of the users search database. Also, as the user is surfing the web, performing searches, and marking content as relevant, irrelevant, or not sure, the system is collecting and storing all of this data. When the user wants to see a Summary Page of all of the data, he or she can click on a Summary Button, which will produce a Summary Page and present it to the user. This Summary Page can show what links, text selections, images, and other data that the user marked as relevant, irrelevant, or not sure. It can display this data in various formats that allow the user to quickly retrieve the information of importance without the clutter of irrelevant or not of interest Search Results. The Search Summary page can also provide a way to share the Search Summary with a colleague. The various information can persist in a database on a network. Similar to various social media software, the user should be able to email or post their results. Colleagues could then further refine the search, starting from where the first user left off.

The inventive system can be added into existing search engines or run separately from existing search engines. Various search web sites that could benefit from this type of interface are:
google.com
https://duckduckgo.com/
http://www.lycos.com/
http://www.bing.com/
yahoo.com
http://www.ask.com/
http://search.aol.com/
http://www.wow.com/
http://www.dogpile.com/

These sites will often give you related searches, and they will often have an advanced search where you can do Boolean operations and such, but they do not let you mark a page as relevant or irrelevant in order to refine the search. Nor do they allow you to review your search history, highlight relevant or irrelevant text, etc. Nor do they allow yon to mark the relevancy of pages and content that is not part of their web page. In addition, various software search products could benefit from the present invention by incorporating it into their product to improve search speed and search results.

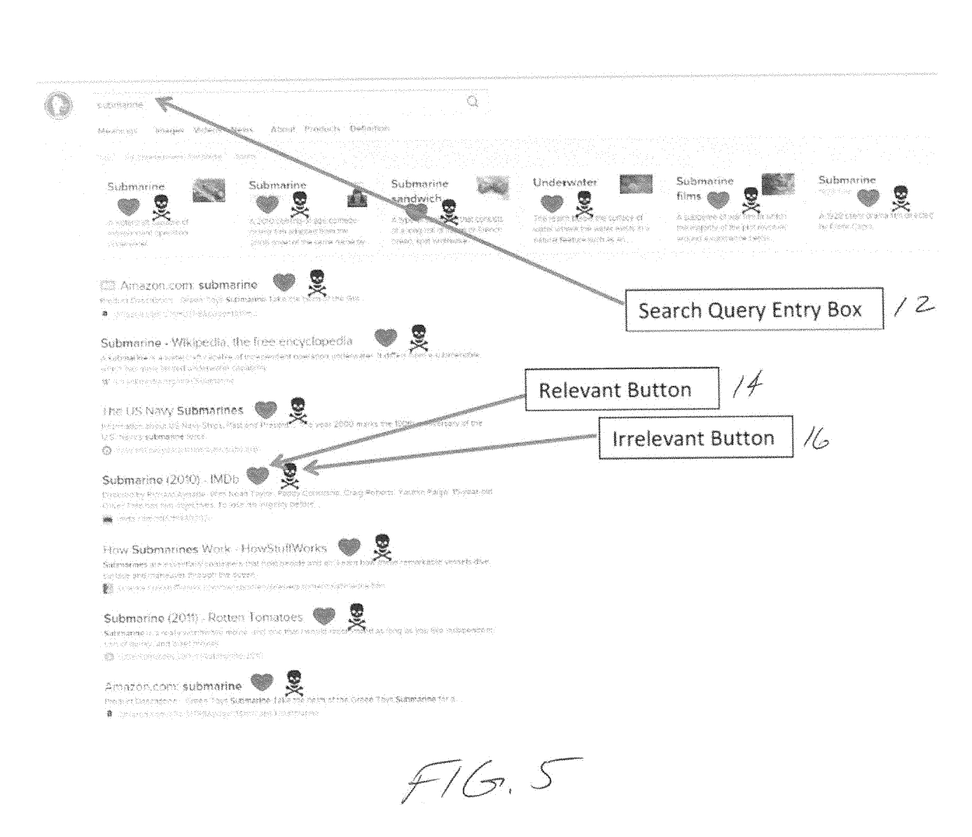

FIGS. 5 through 7 depict an example of how the inventive process could be implemented. In this case, the search engine DuckDuckGo could be modified with the present invention in order to improve search abilities. FIG. 5 shows how a search word is entered in search query entry box 12. Each search result is provided with two buttons—relevant button 14 and irrelevant button 16. The user may prefer only having these two buttons and should be able to select which buttons are displayed, using a Settings Dialog.

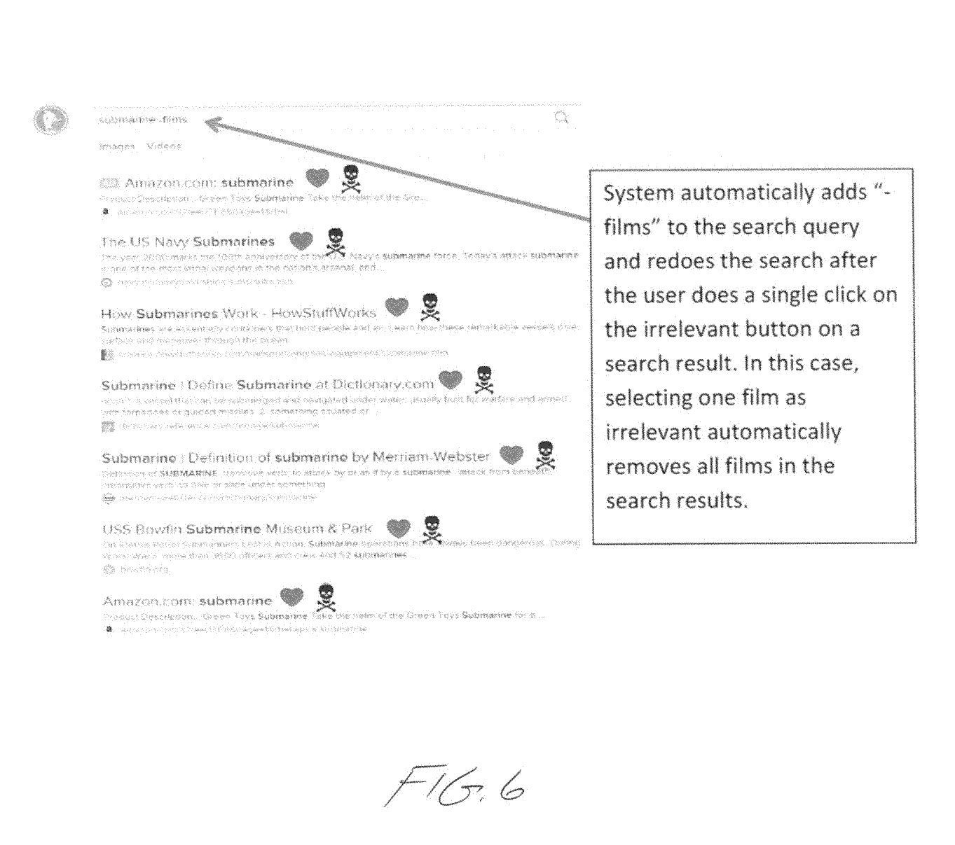

In this case, after searching for “submarine” the user decides that they are not interested in any movies named Submarine. The user clicks the Irrelevant Button, in this example shown as a skull and crossbones. After doing so, the system determines that the user is not interested in films. Several things could happen at this point. The system could go through all the search results and remove those about films. Or it could refine the search terms by adding a minus term to eliminate the site that irrelevant result corresponded to, in this case by adding “-site: imdb.com” to the results. Or it could refine the search terms and add “films” to the search (as shown in FIG. 6), by detecting that the word “film” appears with high frequency at the site that the Search Result corresponds to, now making the Refined Search Query be “submarine -films”. Note that two movies were removed from the results in FIG. 6 by clicking the irrelevant button on one of them. In general, it can be expected that marking a single irrelevant result by clicking on the Irrelevant Button may significantly reduce the number of irrelevant results shown.

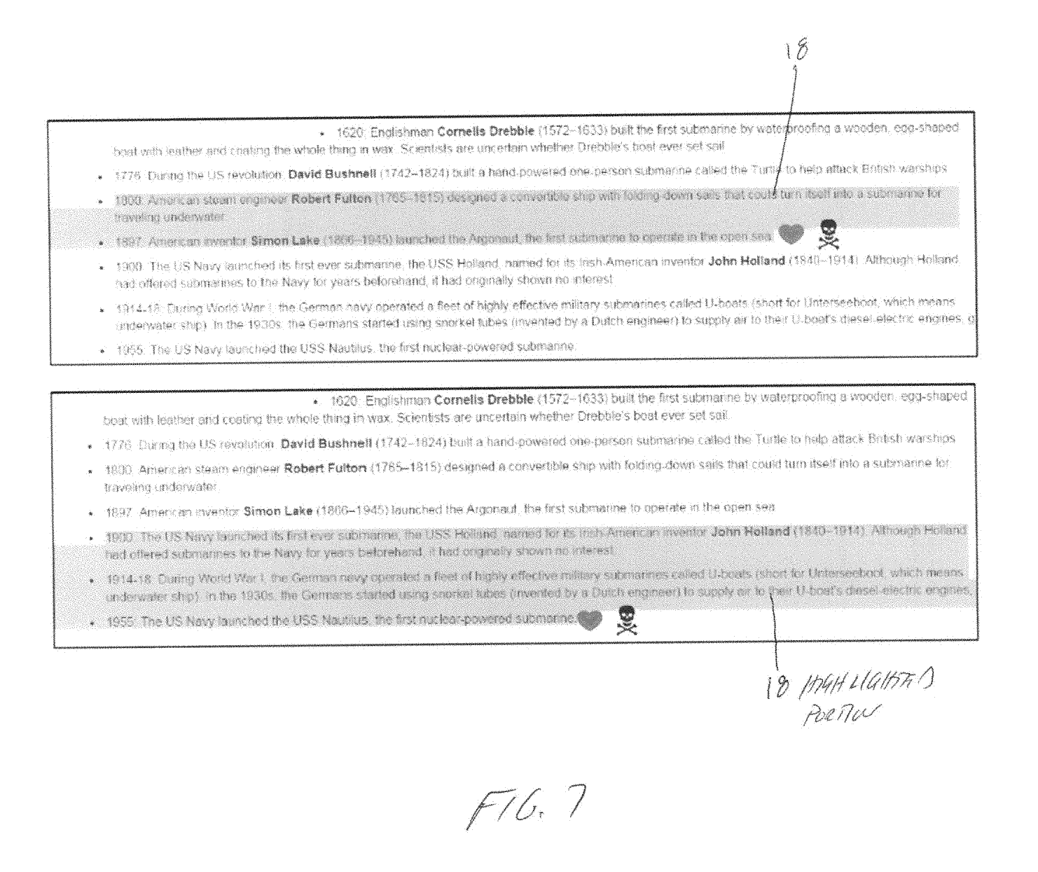

As another example, consider a user who has been surfing the web and comes upon a portion of an article that he finds interesting. He can highlight the interesting text and click a “relevant” button that pops up. That portion of text is then added to his search information as to what is relevant. Another portion of the article might be irrelevant, so he highlights that portion and marks it as being irrelevant. When the user continues his search, these text portions will then be considered in the search. For example, suppose someone is researching submarine history and in a general article on submarines they find a portion of text on who invented the submarine. Suppose they are most interested in 1800 submarine history. Then they could highlight the portions concerning the 1800s (shown as highlighted portion 18 in FIG. 7) and mark them as relevant, and highlight the portions concerning pre and post 1800s and mark them as irrelevant.

In another example of the invention in action, consider image searches. If one searches for “wild cats” there are several representative images that result. If the user has a sense of what the animal in question looks like, but doesn't know its name, the user could mark some images as relevant and irrelevant. In addition, the user could also highlight portions of images to indicate the features that the user is looking for.

To add entertainment value, each time the user marks something as relevant, not sure, or irrelevant, something entertaining could happen on the User Interface. Irrelevant links would probably be the most useful since entertainment could reduce some of the frustrations caused by large numbers of irrelevant results. The following are possible things that could happen. A preferred embodiment would implement a few of these options and either cycle between them or let the user indicate which one to use in a Settings Window:

(1) Have a virtual pirate on the screen shoot a cannon on an irrelevant Search Result, making it explode, and having that Search Result disappear;

(2) Have a virtual sledge hammer smash an irrelevant Search Result;

(3) Have a virtual killer robot walk up to an irrelevant Search Result and karate chop it; and

(4) Have a virtual avatar of a celebrity say something clever about an irrelevant Search Result before destroying the result. For example, Mr. T could say “I pity the man who gives me irrelevant Search Results.” Or Arnold Schwarzenegger could say “Come with me if you want relevant Search Results.” Of course, there are many other potentials.

Someone skilled in the art of Web Programming should be able to implement these and other entertaining possibilities when clicking on an Irrelevant Link Button. As one example, one could use or modify FontBomb, a JavaScript program that can virtually “blow up” text on web pages.

There are numerous state of the art search engines and numerous search tools. However, they either a) require the user to expend a lot of effort to communicate what the user thinks is relevant and irrelevant, for example by creating a complex search query that might require a lot of typing or they b) try to infer what the user thinks is irrelevant or relevant by observing user behavior, such as what pages where followed, the order of clicks, etc. In addition, they do not organize the search history very well, thereby making it difficult for users to document their searches, or refine their searches at a later date, or allow colleagues to view and refine their searches.

It is often frustrating to use search tools due to the large volume of irrelevant results and the difficulty in finding hard to find information that may require a very precise search phrase, or a lot of “web surfing” to dig down into pages that contain the information you are looking for.

Other deficiencies of current search engines include the following:

A. Results are either too broad or too narrow;

B. You cannot continue giving information to the search engine as you surf the pages it found;

C. There is no good way to provide additional relevance or irrelevance information to the search tools besides entering additional search terms;

D. Searches are not remembered for later exploration:

E. After a long search and a lot of surfing it is very difficult to go back to previous pages you were on. Instead you need to find them all over again;

F. If you switch from search engine A to B, B does not have the benefit of knowing what engine A found or what your input to A was;

G. Advance Search forms require a lot of typing and it is difficult to figure out what search terms and criterion to use; and

H. Search engines only return the most popular results. If is often something esoteric that you want to find, which might show up on page 50 or so of the search.

The present invention overcomes these limitations in the following way.

A) (Results are either too broad or too narrow): The present invention provides easy ways for the user to remove irrelevant search results through simple means, such as clicking on an “irrelevant” button. It provides easy ways to broaden the search by allowing the user easy means to add information that is relevant to the search, such as highlighting a portion of relevant text, and pushing a “relevant” button that appears after the text is highlighted.

B) (You cannot continue giving information to the search engine as you surf the pages it found): The present invention allows for persistence of information as the user follows hyperlinks to other pages and documents, so that the user can input search information from any document, not just through a given interface. For example, if the user clicks on hyperlinks, drilling down into other pages, and finds a page of interest that didn't show up in the original search, the user can easily communicate to the search engine that this page, and pages similar to it are of interest, for example by clicking on a “relevant” button that appears on the page.

C) (There is no good way to provide additional relevance or irrelevance information to the search tools besides entering additional search terms): The present invention allows for multiple ways for the user to provide additional relevance or irrelevance information to a search, beyond the traditional method of typing in search terms or search questions. These include clicking on “relevant” and “irrelevant” buttons that the system places on web pages and document, highlighting portions of a document and clicking on a “relevant” or “irrelevant” document, or highlighting portions of images.

D) (Searches are not remembered for later exploration): In the present invention, relevancy information entered by the user is stored either locally or on a remote server. This both allows the information to persist as the user explores additional pages and allows for the user to continue or review the search at a later time. In addition, if stored on a remote server, it allows the user to share the search with colleagues.

E) (After a long search and a lot of surfing it is very difficult to go back to previous pages you were on. Instead you need to find them all over again.): In the present invention, since the pages and documents marked as relevant are remembered, the user can easily go back to a page of interest by reviewing the pages marked as relevant.

F) (If you switch from search engine A to B, B does not have the benefit of knowing what engine A found or what your input to A was): In the present invention, the information that the user marks as relevant or irrelevant can persist between search engines. After performing a search on engine A and marking documents as relevant or irrelevant, the user can switch to search engine B. The present invention can then be used to automatically determine search criterion for engine B based on the prior user input.

G) (Advance Search forms require a lot of typing and it is difficult to figure out what search terms and criterion to use.): The present invention automatically determines advanced search criterion based on simple intuitive user input so that the user is not burdened in having to know search tool syntax nor does the user have to determine what advanced search inputs they should use. Instead the present invention, allows for automatic determination of search criterion based on documents that the user marked as relevant or irrelevant.

H) (Search engines only return the most popular results. It is often something esoteric that you want to find, which might show up on page 50 or so of the search.): In the present invention, if popular results are irrelevant, the user can eliminate them by marking them as irrelevant. In addition, if the user finds something esoteric by following hyperlinks to an unpopular but relevant site, the user can mark that site as relevant, which will then allow for further search queries to find related sites, even if they are not popular.

The present invention allows for multiple ways of signifying relevance of information. These include, but are not limited to,

1. Providing “relevant”, “not sure”, and “irrelevant” buttons next to search results, hyperlinks, images, videos, or portions other electronic documents.

2.Providing “relevant”, “not sure”, and “irrelevant” buttons on entire web pages or documents.

3. Providing a means for the user to highlight portions of a text document, and mark the portion as relevant, irrelevant, or not interesting.

4. Providing a means for the user to highlight a portion of an image and marking it as relevant or irrelevant.

5. Providing a means to take a photograph of a document and provide that document to the search tool as being relevant or irrelevant.

Given documents, links, portions of documents, and other information that, the user marks as relevant or irrelevant, there are many means that the present invention provides for refining searches or performing additional searches based on that information. These include, but are not limited to,

A) Perform statistics on the documents marked as relevant and irrelevant. Such statistics include things such as word relevancy analysis. There are many means in the current literature for this analysis, for example “Term Frequency Inverse Document Frequency (TP-IDF)”. Words which are measured to be relevant that are found in documents that the user marks as relevant but are not found often in documents that the user marks as irrelevant are good candidates for positive search terms, whereas words that are measured to be relevant in documents that the user marks as irrelevant but are not often found in documents that the user marks as relevant are good candidates for negative search terms.

B) Use machine learning techniques to identify relevant and irrelevant features based on the documents that user marks as relevant and irrelevant. For example, if the user highlights portions of images and marks them as relevant or irrelevant, image classification software that uses deep convolution neural nets can see which features are selected by the relevant images and which by the irrelevant images and increase the propensity to produce positive results for the relevant features and reduce the propensity to produce positive results for the irrelevant features.

C) Use “Mechanical Turks”, individuals who work from home to perform computational tasks, to search for additional information, based on information the user marked as relevant or irrelevant. This potential would be significantly more expensive, but might be useful for advanced users who can revisit their search later and who place a high value on finding relevant results.

Another way to determine the relevancy of new pages that have not been marked by the user, based on the pages that the user has marked as relevant or irrelevant, is to use the Page Rank algorithm described in Patent U.S. Pat. No. 6,285,999 or similar improvements that have been made to standard search engines. However, PageRank and other algorithms work by counting the number and quality of links to a page to determine a rough estimate of how important the website is. Instead, with the present invention, a similar algorithm can be used, but with the human relevancy scores as the basis for the scores for other pages. For example, a page can be scored with the following scores:

A) Propensity of words in the page as compared to words in pages that are marked as relevant and pages that are marked as irrelevant.

B) Propensity of links from pages marked as relevant and links from pages marked as irrelevant to the page in question.

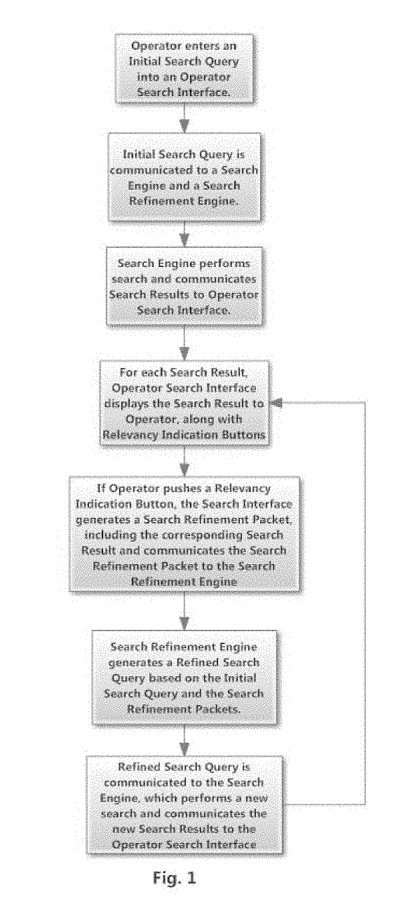

FIG. 1 describes the steps carried out in a preferred embodiment of the invention. An Initial Search Query 100 is used to generate Search Results 140 by a Search Engine 120. The Operator 10 can then push various Relevancy Indication Buttons 150, 151, 152, 153. This information is then conveyed to a Search Refinement Engine 130, which produces a Refined Search Query 170 so that the Search Engine 120 can produce refined Search Results 140. This embodiment comprises the following steps:
1001: Operator 10 enters an Initial Search Query 100 into an Operator Search Interface 110.
1002: Initial Search Query 100 is communicated to a Search Engine 120 and a Search Refinement Engine 130.
1003: Search Engine 120 performs search and communicates Search Results 140 to Operator Search Interface 110.
1004: For each Search Result 140, Operator Search Interface 110 displays the Search Result 140 to Operator 10, along with Relevancy Indication Buttons 150.
1005: If Operator 10 pushes a Relevancy Indication Button 150, the Search Interface 110 generates a Search Refinement Packet 160, including the corresponding Search Result 140 and communicates the Search Refinement Packet 160 to the Search Refinement Engine 130.
1006: Search Refinement Engine 130 generates a Refined Search Query 170 based on the Initial Search Query 100 and the Search Refinement Packets 160.
1007: Refined Search Query 170 is communicated to the Search Engine 120, which performs a new search and communicates the new Search Results 140 to the Operator Search Interface 110.
1008: Loop back to step 1004.

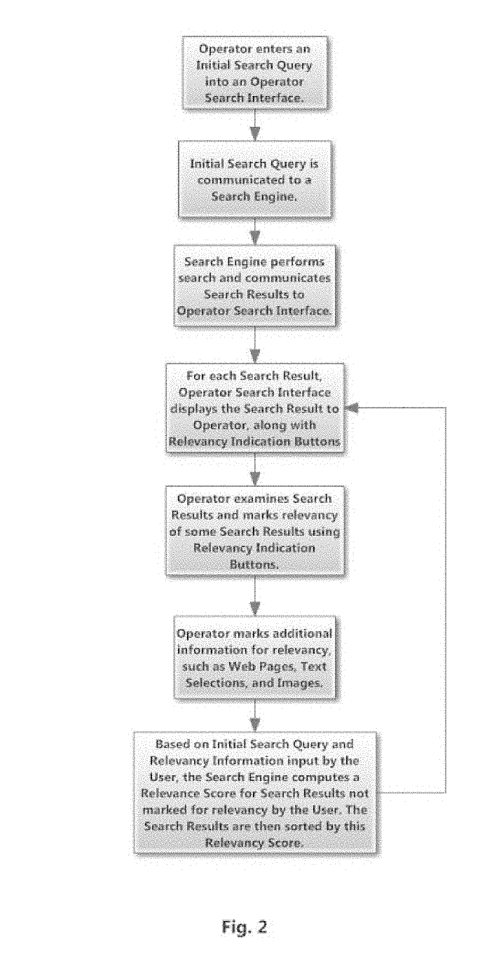

FIG. 2 provides a flowchart for another embodiment of the invention. This embodiment is similar to the one in FIG. 1, except that instead of producing a Refined Search Query, the Search Engine computes a Relevance Score for some or all of the Search Results that were not marked for relevancy by the user. The Search Results are then sorted by this Relevancy Score. In this way the more relevant Search Results will be placed higher up in the list of Search Results displayed on the Operator Search Interface. This embodiment comprises the following steps:
2001: Operator 10 enters an Initial Search Query 100 into an Operator Search Interface 110.
2002: Initial Search Query 100 is communicated to a Search Engine 120.
2003: Search Engine 120 performs search and communicates Search Results 140 to Operator Search Interface 110.
2004: For each Search Result 140, Operator Search Interface 110 displays the Search Result 140 to Operator 10, along with Relevancy Indication Buttons 150.
2005: Operator 10 examines Search Results 140 and marks relevancy of some Search Results 140 using Relevancy Indication Buttons 150.
2006; Operator 10 marks additional information for relevancy, such as Web Pages, Text Selections, and Images.
2007: Based on Initial Search Query 100 and Relevancy Information 200 input by the User 10, the Search Engine 120 computes a Relevance Score 210 for Search Results 140 not marked for relevancy by the User 10. The Search Results 140 are then sorted by this Relevancy Score 210.
2008: Loop back to step 2004.

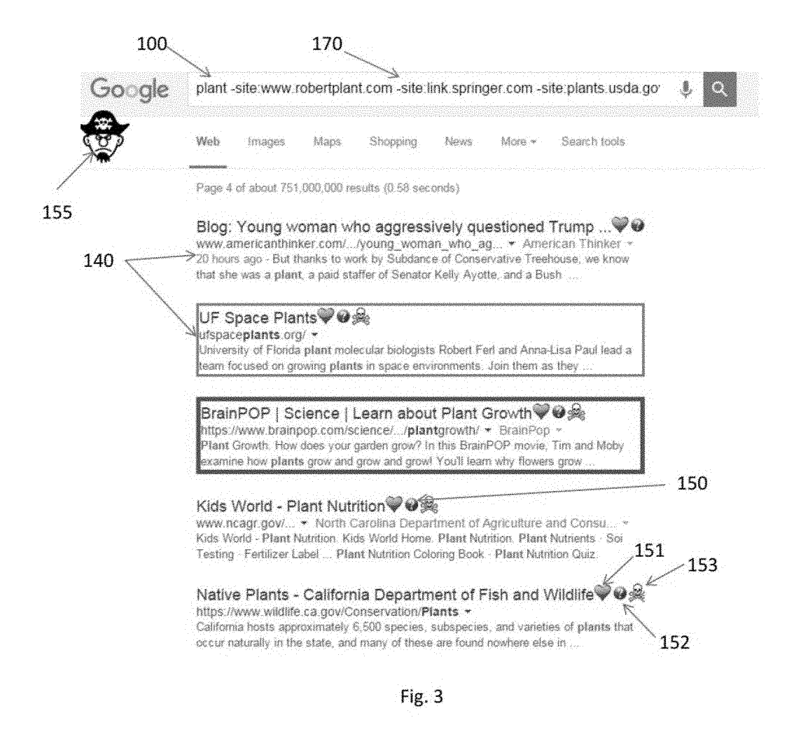

FIG. 3 provides a view of the Operator Search Interface 110, running on the Operator Computer 20. The Initial Search Query 100 was “plant”. The Refined Search Query 170 is now quite long. There are Relevancy Indication Buttons 150 after each Search Result 140. These buttons include Relevant Buttons 151, Not Sure Buttons 152, and Irrelevant Buttons 153. When a button is pressed by the Operator 10, the Operator Search Interface 110 interacts with a Search Engine 120, which may also include a Search Refinement Engine 130. New ordering of Search Results 140 are determined and displayed on the Operator Search Interface 110. When the Operator 10, presses the Search Summary Button 155, a new page appears showing a summary of the Initial Search Query 100, the Relevancy Information 200 input by the Operator 10, all of the Search Results marked as relevant or not sure. This Summary Page can be shared with others through a hyperlink to it.

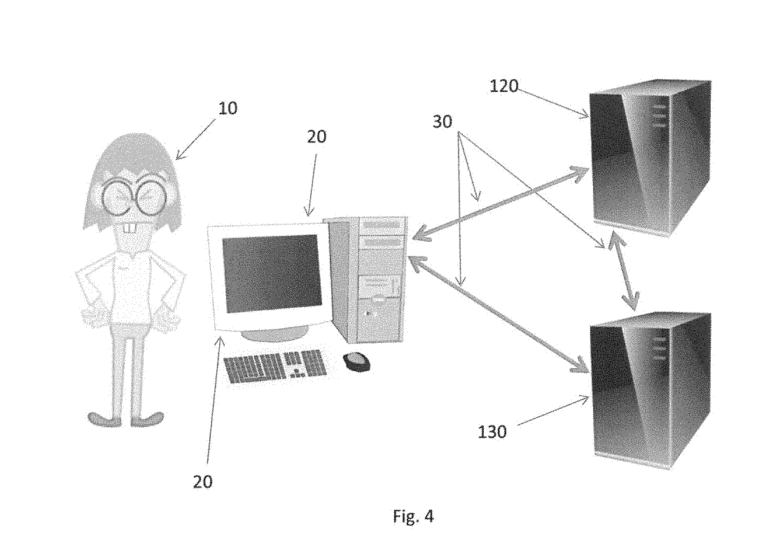

FIG. 4 shows how the various physical components of the invention can be embodied, which is typical of any modem computer system. Operator 10 can use the Operator Search Interface 110 running on the Operator Computer 20. The Operator Computer is connected through a Network Connection 30 to a Search Engine 120 and a Search Refinement Engine 130. Note that the Operator Computer, the Search Engine, and the Search Refinement Engine may be a single computer, or multiple computers and the software that implements the Operator Search Interface, the Search Engine, and the Search Refinement Engine may be a single piece of software, or separate pieces of software.

There are multiple ways that the invention can be embodied. The invention could be used for web searches, patent database searches, e-commerce sites, library hook searches, etc. Nearly any information retrieval system could place Relevancy Indication Buttons on the retrieved results, allowing a User to quickly mark with a single mouse click which retrieved results are relevant or not. Based on that information, the system could then automatically refine the results using a number of different techniques. If the invention is integrated closely as part of an existing information retrieval system, then the invention can use some of the functionality of the existing information retrieval system to help refine the search. But if the invention is used as a front end to existing information retrieval systems, then it will be limited in how it can communicate with the existing information retrieval system, in this case, the system will likely produce refined search queries.

In the preferred embodiment information is marked using Relevant Buttons, Irrelevant Buttons, or Not Sure Buttons, One could also use a slider element or other simple user interface elements.

There are several options how Search Results can be displayed to the user. These include the following:

(A) Highlight Relevant and Not Sure Search Results with a border or by changing their color, while hiding Irrelevant Search Results.

(B) Do not show any marked Search Results, but only showing additional Search Results that have not been marked by the user yet so that the already marked results do not clutter the display. The user can see the marked results later by going to the Summary Page.

(D) Put the different Search Results on different tabs or on different portions of the screen so that the User can easily look from one part to another.

Although the preceding description contains significant detail, if should not be construed as limiting the scope of the invention but rather as providing illustrations of the preferred embodiments of the invention. One skilled in the art may easily devise variations on the embodiments described. Thus, the scope of the invention should be fixed by the claims rather than the examples given.

Having described my invention, I claim:

1. A method allowing a user to increase the relevance of a search result produced by an internet search engine running on a computer and provided on a display, in response to an initial query, comprising:
a. appending each entry in said search result on said display with a user relevance input feature, including a first selectable button indicating relevance and a second selectable button indicating irrelevance;
b. receiving from said user a selection of said selectable buttons;
c. automatically updating said initial query in response to said selection of said selectable buttons in order to create an updated query; and
d. running said updated query through said internet search engine to provide an updated search result.

2. A method allowing a user to increase the relevance of a search result produced by an internet search engine running on a computer and provided on a display, in response to an initial query, comprising:
a. appending each entry in said search result on said display with a user selectable relevance input;
b. receiving from said user a selection of said user selectable relevance inputs;
c. automatically updating said initial query in response to said user selectable relevance inputs; and
d. running said updated query through said internet search engine to provide an updated search result.
